(19) United States
(12) Patent Application Publication
(10) Pub. No.: US 2025/0249719 A1
(43) Pub. Date: Aug. 7, 2025

(54) A SUSPENSION SYSTEM

(71) Applicant: CARBON AREION PTY LTD, Warragul, Victoria (AU)

(72) Inventor: Thomas Luke HOTCHKIN, Pakenham, Victoria (AU)

(21) Appl. No.: 18/854,922

(22) PCT Filed: Apr. 6, 2023
(86) PCT No.: PCT/AU2023/050282

§ 371 Date: Oct. 7, 2024

(30) Foreign Application Priority Data
Apr. 8, 2022 (AU) 2022900931

(51) Int. Cl. B60G 5/06

(52) U.S. Cl. CPC B60G 5/06; B60G 2202/134; B60G 2204/122; B60G 2300/04

(57) ABSTRACT

A suspension system for a pair of wheels of a vehicle is disclosed. The suspension system comprises an inner member and a sleeve member that are coaxially arranged and rotatable relative to each other about the axis and a resilient element that rotatably biases the inner member relative to the sleeve member. The suspension system further comprises first and second arms that are secured to one or other of the inner member and the sleeve member and are configured to be rotatably coupled to respective wheels of the pair of wheels. In use, displacing at least one of the wheels relative to a chassis of the vehicle transfers a force to a respective arm and applies a torque to one of the members relative to the other member resulting in a biasing force which resists the torque and acts to return the displaced wheel back to the ground surface.

### FIELD

The invention relates to a suspension system for vehicle having a pair of wheels.

More specifically, although by no means exclusively, the invention relates to a suspension system for a trailer having a pair of wheels.

The invention also relates to a vehicle, such as a trailer, comprising a pair of wheels and the suspension system according to the invention.

### BACKGROUND

Vehicles, such as road and off-road vehicles, typically comprise a chassis, wheels and a suspension system that connects the chassis to the wheels.

The purpose of the suspension system is to absorb impact energy from bumps in a road/ground surface as the vehicle rides over the bumps which improves the safety and comfort of the ride of the vehicle. The suspension system also helps to maintain contact between the wheels and the road/ground surface which improves handling and performance of the vehicle.

Suspension systems typically comprise a resilient element that is disposed between at least one wheel and a chassis that deforms when the wheel is displaced relative to the chassis. Some resilient elements include coil springs, torsion springs and leaf springs.

Suspension systems may also additionally include a damper, also known as a shock absorber, that assists in attenuating the oscillatory movement of the wheel relative to the chassis.

There are three types of known suspension systems:
1. independent;
2. load sharing; and
3. independent load sharing.

In independent suspension systems, each wheel can be independently displaced relative to the chassis.

In load sharing suspension systems, displacing a wheel results in displacement of another wheel in an equal but opposite direction. This means that the load can be distributed evenly between the wheels. Load sharing suspension systems typically include a walking beam arrangement involving a beam which is pivotably mounted to the chassis in a seesaw configuration; the ends of the beam are typically connected to each wheel.

Independent load sharing suspension systems combine the functionality of independent suspension systems and load sharing suspension systems, i.e. each wheel can be independently displaced relative to the chassis and the load of the vehicle is distributed evenly between the wheels. These systems typically comprise a pair of arms that rotatably mount to the wheels and to the chassis, a walking beam arrangement, and a resilient element disposed between the arms and the walking beam. A disadvantage with independent load sharing suspension systems is that they can be complex and expensive to manufacture and maintain.

The invention provides an alternative independent load sharing suspension system to systems known to the applicant.

### SUMMARY

In broad terms, the invention provides a suspension system for a vehicle having a chassis and a pair of wheels for moving the vehicle along a ground surface, the suspension system comprising: an inner member and a sleeve member that are coaxially arranged and rotatable relative to each other about the axis; a resilient element that rotatably biases the inner member relative to the sleeve member; the inner member, the sleeve member and the resilient element being freely rotatable relative to a chassis of the vehicle about the axis; a first arm rotatably coupled to a first wheel of the pair of wheels and being secured to the inner member; a second arm rotatably coupled to a second wheel of the pair of wheels and being secured to the sleeve member; wherein displacing one of the wheels relative to the chassis transfers a force to the respective arm and applies a torque to one of the members relative to the other member resulting in a biasing force which resists the torque and acts to return the displaced wheel back to the ground surface.

More particularly, although not exclusively, the invention provides a suspension system for a vehicle having a chassis and a pair of wheels for moving the vehicle along a ground surface, the suspension system comprising: an inner member and a sleeve member that are coaxially arranged in relation to an axis and rotatable relative to each other about the axis; a resilient element which biases the inner member relative to the sleeve member from a tensioned state to a relaxed state; the inner member, the sleeve member and the resilient element being configured to be freely rotatable relative to the chassis of the vehicle about the axis; a first arm secured to the inner member and configured to be rotatably coupled to a first wheel of the pair of wheels; a second arm secured to the sleeve member and configured to be rotatably coupled to a second wheel of the pair of wheels; wherein, in use, displacement of the first wheel or the second wheel or both wheels relative to the chassis transfers a force to the respective first and second arm which rotates the inner member relative to the sleeve member and produces a torque on the resilient element that tensions the resilient element from the relaxed state to the tensioned state and in response the resilient element generates a biasing force which resists the torque and acts to return the resilient element from the tensioned state to the relaxed state and in doing so transfers an opposing force to the respective first and second arm to maintain contact between the wheels and the ground surface.

In some embodiments, in use, displacement of the first wheel or the second wheel relative to the chassis transfers a force to the respective first and second arm which rotates the inner member relative to the sleeve member and produces a torque on the resilient element that tensions the resilient element from the relaxed state to the tensioned state and in response the resilient element generates a biasing force which resists the torque and acts to return the resilient element from the tensioned state to the relaxed state and in doing so transfers an opposing force to the respective first and second arm to maintain contact between the wheels and the ground surface.

In some embodiments, in use, displacement of both wheels relative to the chassis transfers a force to the respective first and second arm which rotates the inner member relative to the sleeve member and produces a torque on the resilient element that tensions the resilient element from the relaxed state to the tensioned state and in response the resilient element generates a biasing force which resists the torque and acts to return the resilient element from the tensioned state to the relaxed state and in doing so transfers an opposing force to the respective first and second arm to maintain contact between the wheels and the ground surface.

In the context of this application, the term “freely rotatable” includes rotation with limited resistance. An example of “freely rotatable” is a bearing or a bushing. A bearing or a bushing assists in rotating an object with minimal frictional resistance. This term is in contrast to the term “rotatably biased” which means that rotation is resisted in a material way, i.e., not in a limited way.

By virtue of the inner member, the sleeve member and the resilient element being freely rotatable relative to the chassis of the vehicle about the axis, the arms function as a walking beam. This allows the suspension system to be load sharing. Simultaneously, by virtue of the resilient element which biases the inner member relative to the sleeve member, each wheel can be independently displaced relative to the chassis. The combined effect of the above results in an independent load sharing suspension system.

In effect, the present invention merges the function of walking beam and arms. This results in an independent load sharing suspension system that has fewer moving parts and is therefore simpler to manufacture and easier to maintain than conventional independent load sharing suspension systems.

The first arm may have an end that can be rotatably coupled to the first wheel of the pair of wheels and an opposing end secured to the inner member. However, it is also envisaged that the first arm may be configured to be rotatably coupled to the first wheel at any position along a length of the first arm. It is also envisaged that the first arm may be configured to be secured to the inner member at any position along the length of the first arm.

The second arm may have an end that can be rotatably coupled to the second wheel of the pair of wheels and an opposing end secured to the sleeve member. However, it is also envisaged that the second arm may be configured to be rotatably coupled to the second wheel at any position along a length of the second arm. It is also envisaged that the second arm may be configured to be secured to the sleeve member at any position on the length of the second arm.

The resilient element may comprise a connection between the inner member and the sleeve member at a first position along a length of the members.

The connection may be formed by any means known in the art. For example, by welding the inner member and sleeve member together or by using fasteners.

The first position may be at or proximate a first end of the inner member and a first end of the sleeve member. However, it is also envisaged that the first position may be at an intermediate position between respective ends of the inner member and sleeve member.

In some embodiments, the biasing force may be provided by the internal strain energy of the inner member and sleeve member, by virtue of the connection. In this embodiment, the spring rate of the suspension system is a function of the modulus of rigidity of the inner member and sleeve member, the quad diameter (diameter raised to the power of four) of the inner member and sleeve member and the lengths of the inner member and the sleeve member. In this embodiment, the modulus of rigidity is a function of the material properties of the inner member and the sleeve member. For example, carbon steel has a modulus of rigidity of 77 GPa. In this embodiment, the spring rate is proportionate to the modulus of rigidity and to the quad diameter of the inner member and sleeve member and inversely proportional to the lengths of the inner member and sleeve member. Increasing the spring rate results in a stiffer suspension and conversely reducing the spring rate results in a softer suspension. A person skilled in the art would appreciate that the suspension system spring rate may be tuned by altering the above defined variables.

An advantage to this arrangement is that it negates the inclusion of a separate component that acts as a resilient element. This is because the mechanical properties of the inner member and sleeve member themselves provide the biasing force. As such, this arrangement reduces the number of components resulting in a suspension system having fewer moving parts which improves ease of manufacture and maintenance.

The first arm may be secured to the inner member at a second position that is distal from the first position. However, it is also envisaged that the second position may be proximal to the first position.

The second position may be at or proximate a second end of the inner member. However, in some embodiments, the second position may at an intermediate position between the first and second ends of the inner member.

The second arm may be secured to the sleeve member at a third position that is distal from the first position. However, it is also envisaged that the third position may be proximal to the first position.

The third position may be at or proximate the second end of the sleeve member. However, in some embodiments, the third position may be at an intermediate position between the first and second ends of the sleeve member.

The inner member may protrude from the sleeve member. However, in some embodiments, the inner member may be flush with the sleeve member. It is also envisaged that the inner member may be recessed within the sleeve member. As an example, if the inner member is recessed within the sleeve member, the sleeve member may include a cut-out to allow movement of the first arm.

There may be a radial gap between the members that separates the members to facilitate rotational displacement of the members. The gap may be between 0.2 mm and 50.0 mm, optionally between 0.2 mm and 20.0 mm, optionally between 0.2 mm and 1.0 mm.

At least one of the inner member and the sleeve member may have a port to allow the flow of lubricant into the gap. The port may be located in the sleeve member. However, it is also envisaged that the port may be located in the inner member. A valve may be fitted to the port, for example a non-return valve, to control flow of lubricant into or out of the gap or both into and out of the gap.

The resilient element may be positioned between the inner member and the sleeve member. In some embodiments, the resilient element is positioned in the gap between the members. It is also envisaged that the resilient element could be positioned partly or wholly outside of the gap.

The resilient element may comprise a deformable element. The deformable element may be configured to compress under tension to resist the torque that is applied to the resilient element. For example, a deformable element made from an elastomeric material.

The resilient element may comprise a torsion spring. A torsion spring is a spring that works by twisting its end along its axis. In contrast, a coil spring works by axially compressing.

The torsion spring may be positioned between the inner member and the sleeve member. For example, the torsion spring may be positioned in the gap. However, it is also envisaged that the torsion spring could be positioned partly or wholly outside of the gap. The torsion spring may be configured to resist the torque that is applied to one of the inner member and sleeve member relative to the other of the inner member and sleeve member.

The inner member may be a cylindrical rod. However, it is also envisaged that the inner member may have any other shaped cross-section, for example: rectangular; triangular; or hexagonal.

The sleeve member may be a cylindrical tube. However, it is also envisaged that the sleeve member may have any other shaped cross-section, for example: rectangular; triangular; or hexagonal.

The vehicle may be a trailer. The trailer may be a road trailer or an off-road trailer.

The invention also provides a vehicle comprising a pair of wheels and the suspension system as defined above.

The vehicle may be a trailer.

It is also envisaged that the suspension system according to the present invention may be adapted for any other road or off-road vehicle, including: tractors; trucks; busses; semi-trailers; and tanks.

### BRIEF DESCRIPTION OF THE DRAWINGS

The invention is described further by way of example with reference to the accompanying drawings of which:

FIG. 1 is a perspective view of a suspension system according to an embodiment of the present invention;

FIG. 2 is front view of the suspension system shown in FIG. 1;

FIG. 3 is a side view of the suspension system shown in FIG. 1;

FIG. 4 is a top view of the suspension system shown in FIG. 1;

FIG. 5 is a side sectional view of the suspension system shown in FIG. 4 in a plane that extends through the line X-X;

FIG. 5A is an enlarged view of the circled area A in FIG. 5;

FIG. 5B is an enlarged view of the circled area B in FIG. 5;

FIG. 6A is a perspective sectional view of the suspension system shown in FIG. 4 in a plane that extends through the line X-X, with only an inner member, a sleeve member, and a first arm shown in solid lines and the remaining components shown in phantom;

FIG. 6B is a perspective sectional view of the suspension system shown in FIG. 4 in a plane that extends through the line X-X, with only an inner member, a sleeve member, and a second arm shown in solid lines and the remaining components shown in phantom;

FIG. 7 is an image of the underside of a trailer chassis with a suspension system according to an embodiment of the present invention installed thereon; and

FIG. 8 is an image of a trailer equipped with a suspension system according to an embodiment of the present invention in which one of the pair of wheels has entered a ditch.

### DETAILED DESCRIPTION OF SPECIFIC EMBODIMENTS

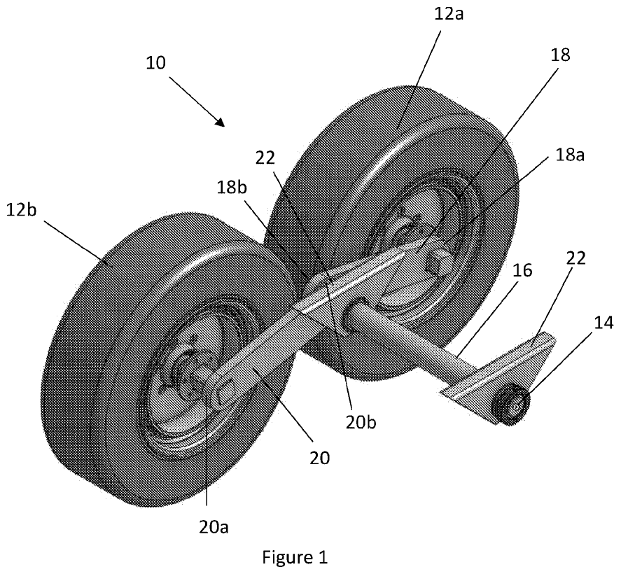

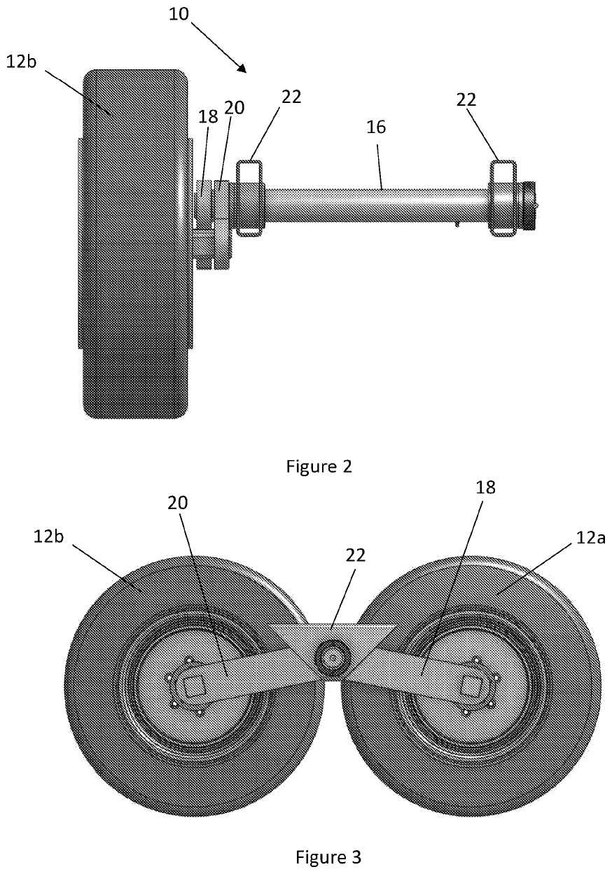

FIGS. 1-6 show a suspension system 10 for a pair of wheels 12a, 12b of a vehicle according to an embodiment of the present invention.

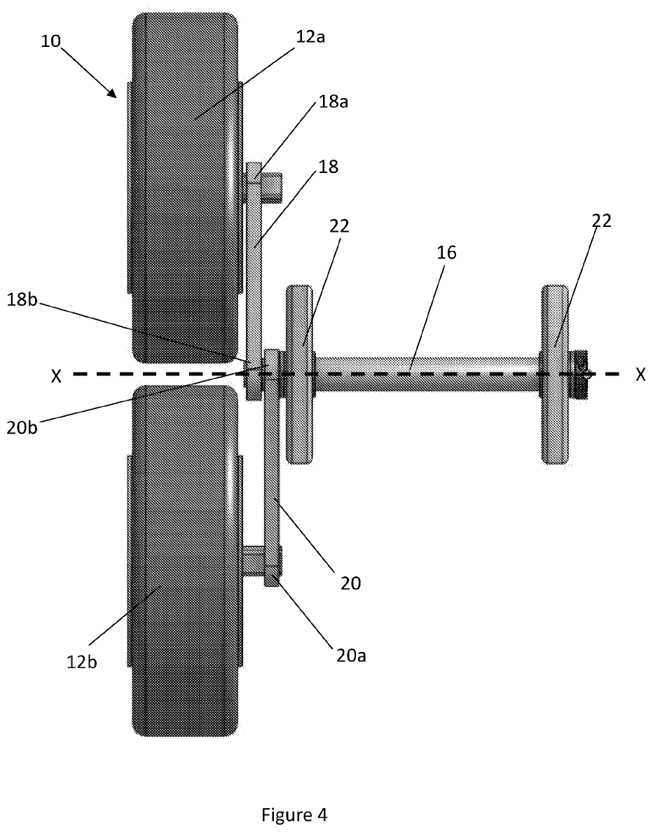

The suspension system 10 comprises: an inner member 14 (see FIGS. 4, 5A, 5B, 6A, 6B) and a sleeve member 16 that are coaxially arranged in relation to an axis and rotatable relative to each other about the axis. The suspension system 10 further comprises a first arm 18 and a second arm 20.

As shown in FIGS. 1 and 4, the first arm 18 has a first end 18a rotatably coupled to a first wheel 12a of the pair of wheels and a second end 18b that is secured to the inner member 14. The second arm 20 has a first end 20a rotatably coupled to a second wheel 12b of the pair of wheels and a second end 20b that is secured to the sleeve member 16.

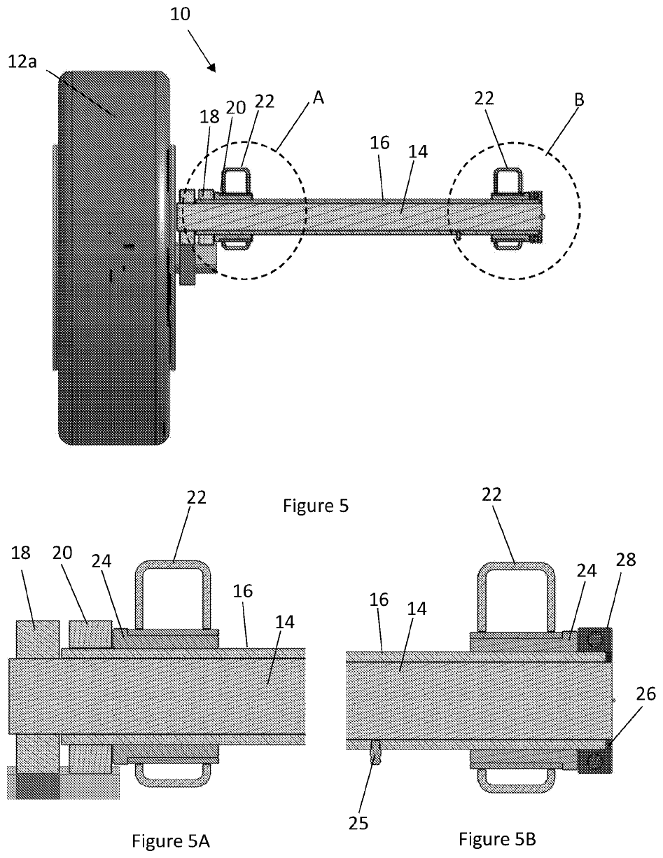

As best shown in FIGS. 5A and 5B, the inner member 14 and sleeve member 16 are freely rotatably housed within a pair of brackets 22. The bracket 22 is secured, welded or otherwise, to a chassis of a vehicle. Each bracket 22 comprising a polyurethane (PU) bushing 24 having a low coefficient of friction. The PU bushing 24 enables free rotation of the inner member 14 and sleeve member 16 relative to the bracket 22, i.e. with limited frictional resistance. The bushing may be made from any other material with a low coefficient of friction, for example polytetrafluoroethylene (PTFE). In addition, it is also envisaged that the PU bushing 24 could be substituted with another suitable bearing, for example: a journal bearing or a roller bearing.

The inner member 14 is a cylindrical rod having a diameter of 50.0 mm and a length of approximately 675.0 mm. The sleeve member 16 is a cylindrical tube having an outer diameter of 63.5 mm, an inner diameter of 50.8 mm, and a length of approximately 635.0 mm.

When coaxially arranged, there is a radial gap of 0.4 mm between the inner member 14 and the sleeve member 16. This gap separates the inner member 14 from the sleeve member 16 to facilitate relative displacement of the inner member 14 and sleeve member 16.

As shown FIG. 5B, the sleeve member 16 has a grease nipple 25 which is a port that allows the gap to be filled with lubricant. The grease nipple 25 comprises a channel with a non-return valve that allows flow unidirectionally along the channel and into the gap.

As shown in FIG. 5, the inner member 14 protrudes from one end of the sleeve member 16. The distance by which the inner member 14 protrudes is 40 mm. The inner member 14 also protrudes from an opposing end of the sleeve member 16 by 5 mm.

With reference to FIG. 5B, the inner member 14 and sleeve member 16 are connected to each other at one end of the members via a circumferential welded joint 26. By virtue of this connection, the inner member 14 and the sleeve member 16 are rotatably biased against each other. In other words, applying a torque to one of the inner member and the sleeve member relative to the other of the inner member and the sleeve member results in a biasing force which resists the torque. A retainer, shaft collar 28, is fitted around the circumferential welded joint 26 to retain the inner member and sleeve member within the brackets 22. In other words, the shaft collar 28 prevents the inner member 14 and sleeve member 16 from sliding out of the bracket 22 in a direction towards the wheels 12a, 12b. At an opposing end, the first and second arms 18, 20 are dimensioned so as to prevent the inner member 14 and sleeve member 16 from sliding out of the bracket 22 in a direction away from the wheels 12a, 12b.

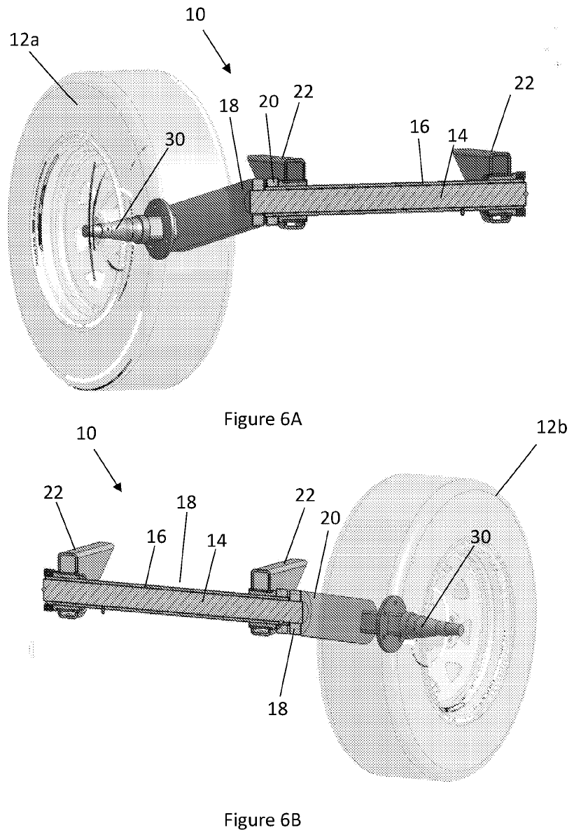

As shown in FIGS. 6A and 6B, the wheels 12a, 12b are rotatably coupled to the respective arm via a stub axle 30.

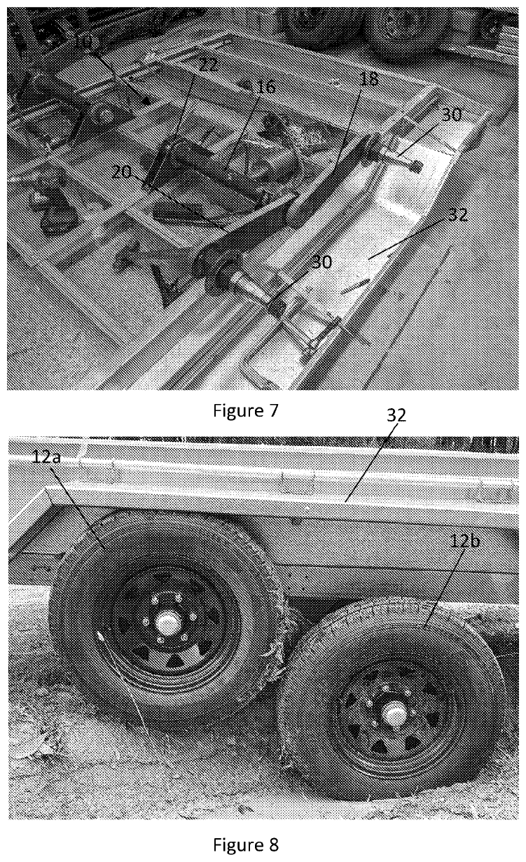

FIGS. 7 and 8 show a suspension system 10 according to an embodiment of the invention attached to a chassis 32 of a trailer. By virtue of the inner member 14 and the sleeve member 16 being connected to each other (via the circumferential welded joint 26), displacing both of the wheels relative to the chassis 32 transfers a force to the respective first and second arm 18, 20 which rotates the inner member 14 relative to the sleeve member 16 and produces a torque on the circumferential welded joint 26 that tensions the circumferential welded joint 26 from a relaxed state to a tensioned state and in response the circumferential welded joint 26 generates a biasing force which resists the torque and acts to return the circumferential welded joint 26 from the tensioned state to the relaxed state and in doing so transfers an opposing force to the respective first and second arm to maintain contact between the wheels and the ground surface.

In the present invention arms 18, 20 together function as a walking beam by moving in a seesaw configuration relative to the chassis by virtue of the inner member 14, the sleeve member 16 being freely rotatable relative to the chassis 32. This allows the suspension system to be load sharing. In effect, if one wheel is displaced the other wheel will be displaced in an equal but opposite direction.

In addition, the arms 18, 20 are rotatably biased together such that rotating one of the arms relative to the other results in a biasing force that resists a torque that is applied. In effect, each wheel is independently displaceable relative to the chassis 32.

The combined effect of the above is an independent load sharing suspension system.

Unlike conventional independent load sharing suspension systems which have several moving parts, including: a walking beam; a pair of arms; and at least one biasing element, the present invention has fewer moving parts because the arms form the walking beam. As such, the present invention does not have a walking beam that is separate from the arms. Therefore, the present invention is simpler to manufacture and easier to maintain than conventional independent load sharing suspension systems.

Whilst in the described embodiment the resilient element is a result of the connection between the inner member 14 and the sleeve member 16, it is also envisaged that other forms of resilient element may be incorporated into the suspension system as either: (a) a substitute for the connection; or (b) in addition to the connection.

For example, a deformable element may be positioned between the inner member 14 and sleeve member 16. For example, in the gap between the inner member 14 and the sleeve member 16. The deformable element may be configured to compress when tensioned as one of the inner member 14 and the sleeve member 16 is rotated relative to the other of the inner member 14 and the sleeve member 16 resulting in a biasing force which resists the torque that is applied.

As another example, a torsion spring may be positioned between the inner member 14 and the sleeve member 16. For example, in the gap between the inner member 14 and the sleeve member 16. The torsion spring can be configured to compress when tensioned as one of the inner member 14 and the sleeve member 16 is rotated relative to the other resulting in a biasing force which resists the torque that is applied.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-17. (canceled)

18. A suspension system for a vehicle having a chassis and a pair of wheels for moving the vehicle along a ground surface, the suspension system comprising:
an inner member and a sleeve member that are coaxially arranged in relation to an axis and rotatable relative to each other about the axis;
a resilient element which biases the inner member relative to the sleeve member from a tensioned state to a relaxed state, wherein the resilient element comprises a connection between the inner member and the sleeve member at a first position along a length of the inner member and the sleeve member;
the inner member, the sleeve member and the resilient element being configured to be freely rotatable relative to the chassis of the vehicle about the axis;
a first arm secured to the inner member and configured to be rotatably coupled to a first wheel of the pair of wheels;
a second arm secured to the sleeve member and configured to be rotatably coupled to a second wheel of the pair of wheels;
wherein, in use, displacement of the first wheel or the second wheel or both wheels relative to the chassis transfers a force to the respective first and second arm which rotates the inner member relative to the sleeve member and produces a torque on the resilient element that tensions the resilient element from the relaxed state to the tensioned state and in response the resilient element generates a biasing force which resists the torque and acts to return the resilient element from the tensioned state to the relaxed state and in doing so transfers an opposing force to the respective first and second arm to maintain contact between the wheels and the ground surface.

19. The suspension system of claim 18, wherein the first position is at or proximate a first end of the inner member and a first end of the sleeve member.

20. The suspension system of claim 19, wherein the first arm is secured to the inner member at a second position that is distal from the first position.

21. The suspension system of claim 20, wherein the second position is at or proximate a second end of the inner member.

22. The suspension system of claim 21, wherein the second arm is secured to the sleeve member at a third position that is distal from the first position.

23. The suspension system of claim 22, wherein the third position is at or proximate a second end of the sleeve member.

24. The suspension system of claim 18, wherein the inner member protrudes from the sleeve member.

25. The suspension system of claim 18, comprising a radial gap between the inner member and sleeve member that separates the inner member and the sleeve member to facilitate rotational displacement of the inner member and the sleeve member.

26. The suspension system of claim 25, wherein at least one of the inner member and the sleeve member has a port to allow the flow of lubricant into the gap.

27. The suspension system of claim 18, wherein the resilient element also comprises a deformable element.

28. The suspension system of claim 18, wherein the resilient element also comprises a torsion spring.

29. The suspension system of claim 18, wherein the inner member is a cylindrical rod.

30. The suspension system of claim 18, wherein the sleeve member is a cylindrical tube.

31. The suspension system defined in claim 18, wherein the vehicle is a trailer.

32. A vehicle comprising a pair of wheels and the suspension system of defined in claim 18.
